(19) United States
(12) Patent Application Publication
(10) Pub. No.: US 2006/0132312 A1
(43) Pub. Date: Jun. 22, 2006

(54) Portal antenna for radio frequency identification

(76) Inventor: Joseph J. Tavormina, Incline Village, NV (US)

Correspondence Address: PERKINS, SMITH & COHEN LLP, ONE BEACON STREET, 30TH FLOOR, BOSTON, MA, 02108, US

(21) Appl. No.: 11/293,006

(22) Filed: Dec. 2, 2005

Related U.S. Application Data
(60) Provisional application No. 60/633,234, filed on Dec. 2, 2004.

(51) Int. Cl. G08B 13/14; H01Q 1/42; H01Q 1/12

(52) U.S. Cl. 340/572.7; 343/872; 343/878

(57) ABSTRACT

An antenna that is used to read and/or write radio frequency identification tags is integrated into the structure of a door frame or other portal. The antenna may incorporate multiple radiating elements and frequency diversity to increase the reliability and accuracy of tag reads or writes, and to provide compatibility with a variety of RFID tags. The design of the antenna may also incorporate a Photonic Band Gap (PBG) antenna substrate.

### CROSS REFERENCE TO RELATED APPLICATIONS

This application claims priority from U.S. Provisional Application 60/633,234, filed Dec. 2, 2004 and which is incorporated herein by reference in its entirety.

### BACKGROUND OF INVENTION

This invention relates to wireless devices, and particularly to an antenna that is mounted on a doorway or portal for use in detecting radio frequency identification (RFID) tags or transponders that are affixed to items, and which are identified as they are passed through the doorway or portal.

Wireless communication devices, including RFID tags and stationary antennas used to read and/or write tag data, are generally known in the art. However, an important unmet need in RFID applications relates to implementation of embedded, low-profile read/write antennas in retail (e.g. in a restaurant) and mobile environments (e.g. from a delivery truck), and in particular while tagged assets are moved through a doorway or a verification portal. The design of application appropriate RFID antennas has not been given due consideration by the companies that currently offer RFID read/write antennas. The technology currently used in the fabrication and function of these antennas has been borrowed from the cellular telephone and/or wireless networking industries, resulting in antennas that are inappropriately packaged for retail and mobile environments, which are fragile, which require installation procedures that are too extensive, and which have an installed cost that is too high.

### BRIEF SUMMARY OF THE INVENTION

The needs of the invention set forth above as well as further and other needs and advantages of the present invention are achieved by the embodiments of the invention described herein below.

According to one aspect of the invention, an antenna for communicating with an RFID transponder is integrated into a portal substantially enclosing an opening. In one embodiment of the invention, integration of the antenna into the portal may be concurrent with manufacture of the portal.

In another embodiment of the invention, the integrated antenna may be a patch antenna, which may include a plurality of patches and microstrip transmission line elements connecting the patches. The plane of the patch antenna may be parallel to the plane defining the opening of the portal.

In a further embodiment of the invention, the antenna may be a Photonic Band Gap antenna that may be multi-element, including a plurality of radiating elements. The Photonic Band Gap antenna may include at least one printed circuit radiating element, which may be in close proximity to a high-impedance reflective backplane, possibly with a separation of one-tenth of a wave length or less.

In an additional embodiment, the integrated antenna may be a loop antenna, where the plane bounded by the loop antenna may be parallel to the plane bounded by the portal or beyond the opening of the portal.

In a certain embodiment, the portal may include a door frame. In another embodiment, the portal may include a plurality of unconnected boundaries. In a still further embodiment, the antenna may be integrated into a vehicle.

According to another aspect of the invention, a system for communicating with an RFID transponder includes a first antenna, capable of transmitting and receiving high frequency electrical signals, a second antenna, capable of transmitting and receiving low frequency electrical signals, and a switch, selectively enabling transmission and reception at the high frequency, at the low frequency, or at both the high and the low frequencies.

In one embodiment of the invention, the first antenna may be a patch antenna and the second antenna may be a loop antenna. In another embodiment of the invention, the first antenna may be a Photonic Band Gap antenna and the second antenna may be a loop antenna.

According to a further aspect of the invention, a method for communicating with an RFID transponder includes transmitting electrical signals to the RFID transponder and receiving electrical signals from the RFID transponder via a plurality of antennas integrated into a portal.

In a certain embodiment of the invention, the method for communicating may include transmitting the electrical signals received from the RFID transponder to a wide area wireless data network. The wide area wireless data network may be based on the IEEE 802.11 standard, on the IEEE 802.16 standard, on the use of cellular data networks, or on the use of other wide area wireless data networks that provide a similar function, such as terrestrial wireless data networks or satellite-based wireless data communication networks.

In a further embodiment of the invention, the method may include switching between the plurality of integrated antennas. In an additional embodiment of the invention, the method may include combining the electrical signals received from the plurality of integrated antennas, where combining may include summing the electrical signals and individual phasing of the electrical signals or weighting of the electrical signals.

According to a different aspect of the invention, a method of integrating an antenna with a portal includes integrating the antenna into the portal during manufacture of the portal.

According to still another aspect of the invention, an antenna for communicating with an RFID transponder is mounted outside a portal substantially enclosing an opening. In one embodiment of the invention, the antenna is adhesively mounted to a surface beyond the portal.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic illustration of an embodiment of the present invention in which portal antennas are mounted to walls adjacent to a door frame;

FIG. 2 is a schematic illustration of an embodiment of the present invention in which portal antennas are directly mounted or otherwise integrated on door frame surfaces facing toward an open room;

FIG. 3 is a schematic illustration of an embodiment of the present invention in which portal antennas are directly mounted or otherwise integrated on door frame surfaces facing the plane of a doorway;

FIG. 4A is a schematic illustration of the contours of electromagnetic field strength produced by portal antennas in an embodiment of the present invention;

FIG. 4B is a schematic illustration of a top view of the contours of electromagnetic field strength produced by portal antennas in an embodiment of the present invention;

FIG. 5 is a schematic illustration of an embodiment of the present invention in which portal antennas are mounted to walls immediately adjacent to a portal opening and countertop;

FIG. 6 is a schematic illustration of an embodiment of the present invention in which portal antennas are directly mounted or otherwise integrated onto a refrigeration unit;

FIG. 7 is a schematic illustration of an embodiment of the present invention in which portal antennas are directly mounted or otherwise integrated onto a delivery truck;

FIG. 8 is a schematic illustration of an embodiment of the present invention in which portal antennas are directly mounted or otherwise integrated onto a fork lift truck;

FIG. 9 is a schematic illustration of an embodiment of the present invention, which shows a series-fed multiple element high frequency portal antenna;

FIG. 10 is a schematic illustration of an embodiment of the present invention, which shows a low frequency portal antenna;

FIG. 11A is a schematic illustration of an embodiment of the present invention, which shows a cross-sectional view of a high frequency portal antenna;

FIG. 11B is a schematic illustration of an embodiment of the present invention, which shows a cross-sectional view of a multiple-mode high frequency and low frequency portal antenna;

FIG. 12A is a schematic illustration of an embodiment of the present invention, which shows diversity switching or combining of signals from multiple portal antenna elements;

FIG. 12B is a schematic illustration of an embodiment of the present invention, which shows a diversity control element where multiple input signals are switched;

FIG. 12C is a schematic illustration of an embodiment of the present invention, which shows a diversity control element where multiple input signals are combined using amplitude and/or phase weights; and

FIG. 13 is a schematic illustration of an embodiment of the present invention, which shows an exploded view of a portal antenna including a photonic band gap antenna substrate.

### DETAILED DESCRIPTION OF THE INVENTION

The present invention addresses the problems of the prior art by advancing the construction and performance of RED tag read/write antennas, with particular emphasis on applications in which items to be identified are passed through a doorway or portal, where a portal corresponds to the boundary of a passageway or opening through which items tagged with RFID transponders traverse in the course of material handling or flow. An ideal solution would integrate the RFID antenna into the structure of a door frame, which can then be further integrated with appropriate automated material handling technology. The integrated solution would produce improvements in read reliability over the current art, perhaps using automated mechanical motion of the carton and tag being read. The present invention advances the state of the art closer to the ideal solution. The utility of the present invention may include UHF tags that operate in the 902-928 MHz frequency range (Class 1 and Class 2 tags), 37 MHZ RFID tags, inductively-coupled 125 KHz tags, or future generation tags that may operate at various frequencies. Low frequency RFID tags operate below 300 MHz, and high frequency RFID tags operate at 300 MHz or higher in frequency.

Applications of the present invention include use in both fixed (i.e. building doorways) and mobile (i.e. on delivery trucks) scenarios. In retail restaurant environments the present antenna may operate at building doorways, at windows, at oven doors, at compartment doors, at refrigerator doors, and at the doors and portals of delivery trucks. The present antenna may be low in profile so as not to block access, and may be designed to withstand high pressure washdowns. In mobile applications the present antenna may be installed on the access doorways and portals of delivery vehicles, and combined with wireless access to a wide area wireless data network that enables reader data to be transmitted and stored in near real-time to a central database. The present antenna may also find application in an automated carton verification system that combines the present antenna portal with automatic material handling equipment. Such a device would move cartons individually through a verification portal and perform a tag read/write with high reliability.

Embodiments of the present invention incorporate patch antenna technology, or Photonic Band Gap (PBG) antenna technology, and/or inductive coil technology that have been appropriately applied for use as in low-profile portal antennas. Patch antenna technology refers to any high frequency (300 MHz or above) antenna constructed using printed circuit fabrication technology and incorporating a low-impedance ground plane as one of the printed circuit layers. PBG antenna technology refers to any high frequency (300 MHz or above) antenna constructed using printed circuit fabrication technology and incorporating a high-impedance PBG surface as one of the printed circuit layers. Loop antenna technology refers to any low frequency (less than 300 MHz) antenna comprised of a multi-turn wire loop constructed using printed circuit fabrication technology and operating on the principle of near-field magnetic coupling between the loop antenna and the low frequency RFID tag.

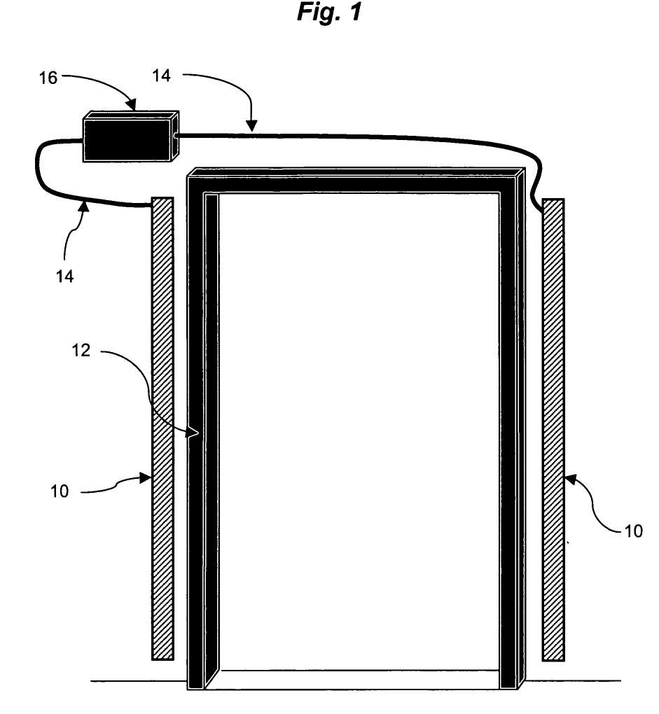

FIG. 1 is a schematic illustration of an embodiment of the present invention in which portal antennas 10 are mounted to the walls immediately adjacent to a full size door frame 12 through which items that have been RFID tagged are transported. The radio frequency (RF) cables 14 used to feed the portal antenna are attached to an RFID electronics module 16.

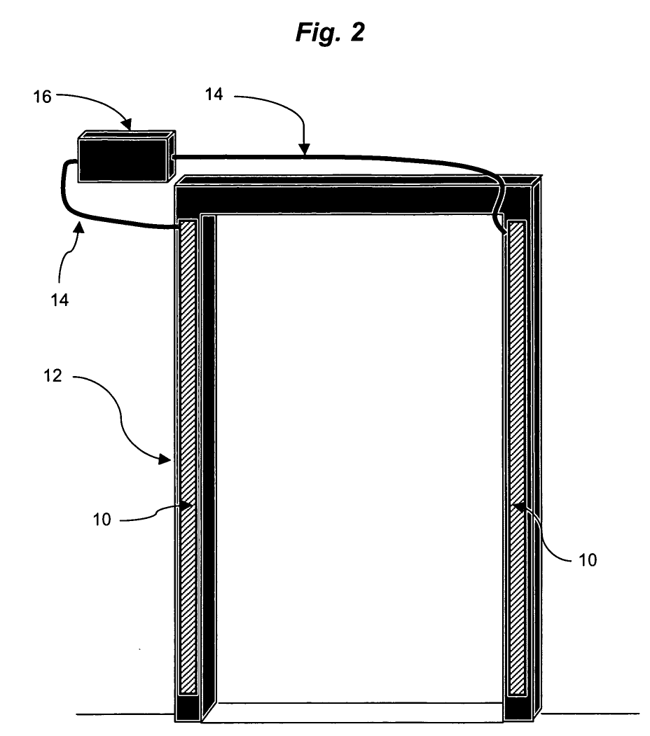

FIG. 2 is a schematic illustration of an embodiment of the present invention in which portal antennas 10 are directly mounted or otherwise integrated, for example, adhesively, on a full size door frame 12, on door frame surfaces that face toward the open room. The RF cables 14 used to feed the portal antenna are attached to an RFID electronics module 16.

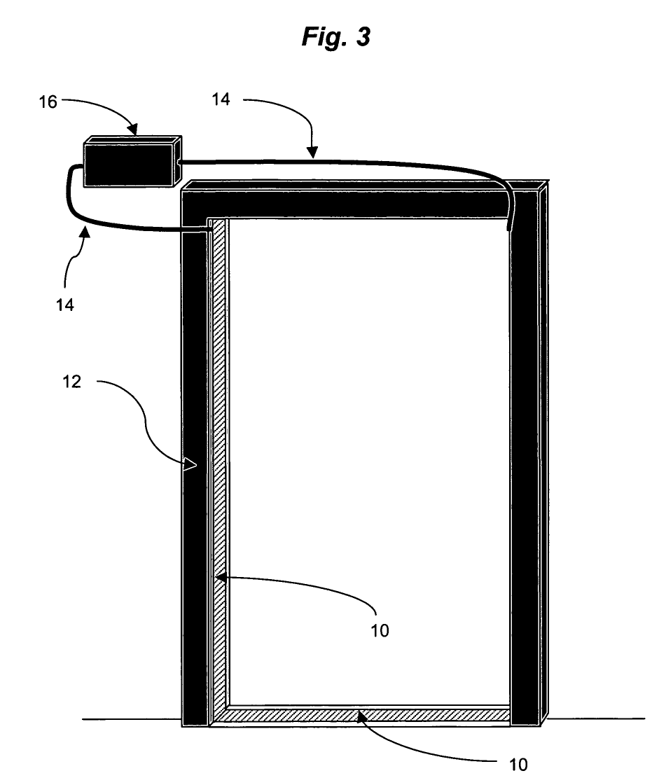

FIG. 3 is a schematic illustration of an embodiment of the present invention in which portal antennas 10 are directly mounted or otherwise integrated on a full size door frame 12, on the door frame surfaces that face the plane of the doorway. In this embodiment the portal antennas may form a complete circuit around the doorway opening, as may be desired to form an inductive coil that surrounds the doorway opening, for best advantage when inductively-coupled low frequency RFID tags are used. The RF cables 14 used to feed the portal antenna are attached to an RFID electronics module 16.

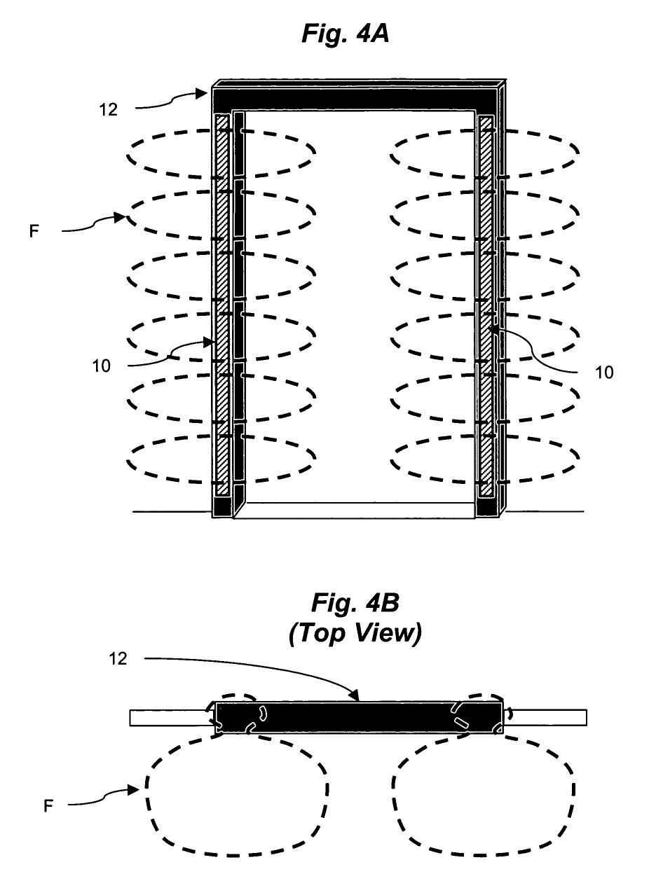

FIG. 4A is a schematic illustration that represents the contours of electromagnetic field strength F produced by the portal antennas 10 in one of the preferred embodiments, and with which the RFID tags interact as they are transported through the doorway 12.

FIG. 4B is a schematic illustration top view of the contours of electromagnetic field strength F produced by one of the preferred embodiments with UHF portal antennas 10 when mounted on a metal or otherwise conductive door frame 12.

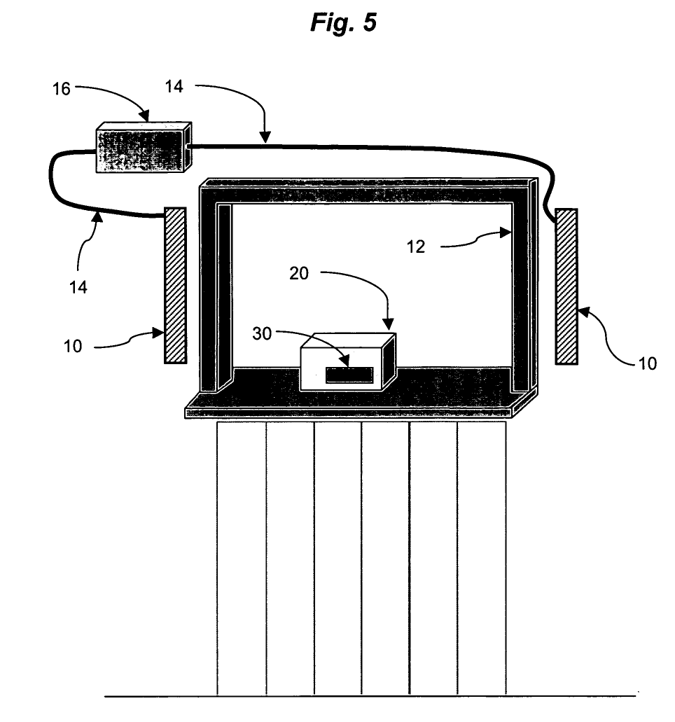

FIG. 5 is a schematic illustration of an embodiment of the present invention in which portal antennas 10 are mounted to the walls immediately adjacent to a portal opening 12 and counter top through which items 20 that have been RFID tagged with RF tag 30 are transported, such as might be found in a stockroom or a tool crib, and used to control inventory and to record the transfer of assets. The RF cables 14 used to feed the portal antenna are attached to an RFID electronics module 16.

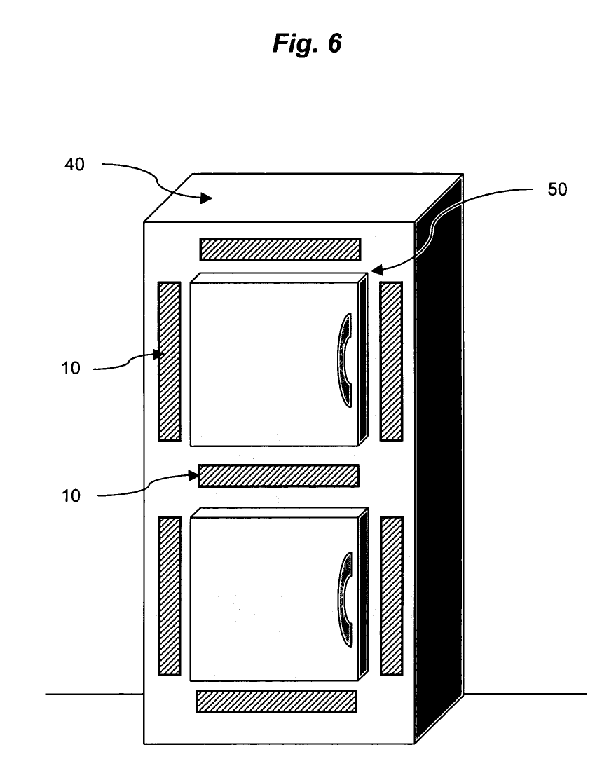

FIG. 6 is a schematic illustration of an embodiment of the present invention in which portal antennas 10 are directly mounted or otherwise integrated on a refrigeration unit 40, on the structure immediately adjacent to the doors 50 that provide access to the interior of the refrigeration unit. This embodiment might be found in a retail restaurant or food processing facility, and permits the automatic recording of the time at which RFID tagged items are placed in or removed from cold storage.

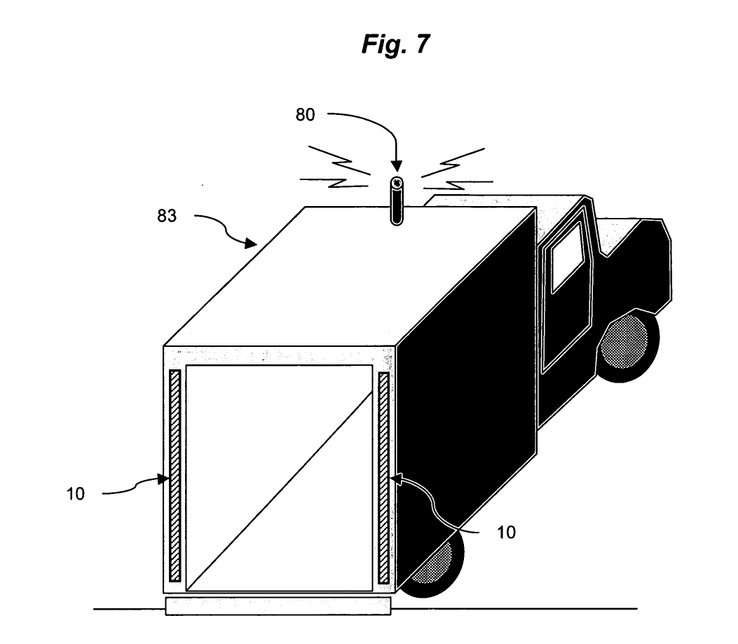

FIG. 7 is a schematic illustration of an embodiment of the present invention in which portal antennas 10 are directly mounted or otherwise integrated on a delivery truck 83, on the structure immediately adjacent to the door that provides access to the interior of the vehicle 83. This embodiment might be employed in the transportation and logistics sector of the supply chain, and permits the automatic identification and recording of the time at which RFID tagged items are placed within or removed from vehicles used to transport inventory or other assets. In this embodiment the information that is read and/or written to RFID tags using the portal antenna is transmitted to and/or from the delivery truck 83 using a secondary wireless data link and its associated antenna 80, as shown in FIG. 7. The transmission may be to or from a local-area wireless data network or a wide area wireless data network. The networks may be based on IEEE 802.11 standard, IEEE 802.16 standard, on the. use of cellular data networks, may be other terrestrial wireless data networks, or may be satellite-based wireless data communication networks.

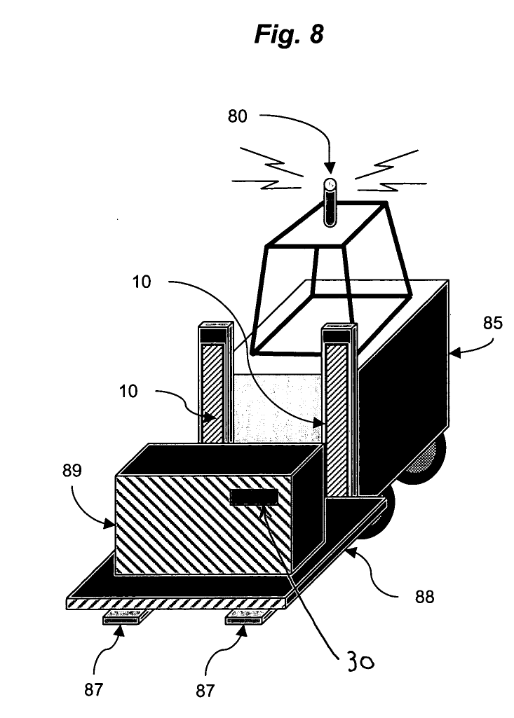

FIG. 8 is a schematic illustration of an embodiment of the present invention in which portal antennas 10 are directly mounted or otherwise integrated on a fork lift truck 85, on the structure immediately adjacent to the tines 87 that are employed to lift pallets 88 that hold RFID tagged items 89. This embodiment might be employed in receiving and shipping applications in which fork lift trucks 85 are employed, to permit the automatic identification and recording of the time at which RFID tagged items 89 are transported by the fork lift truck 88. In this embodiment the information that is read and/or written to RFID tags 30 using the portal antenna 10 is transmitted to and/or from the fork lift truck 85 using a secondary wireless data link and its associated antenna 80, as shown in FIG. 8.

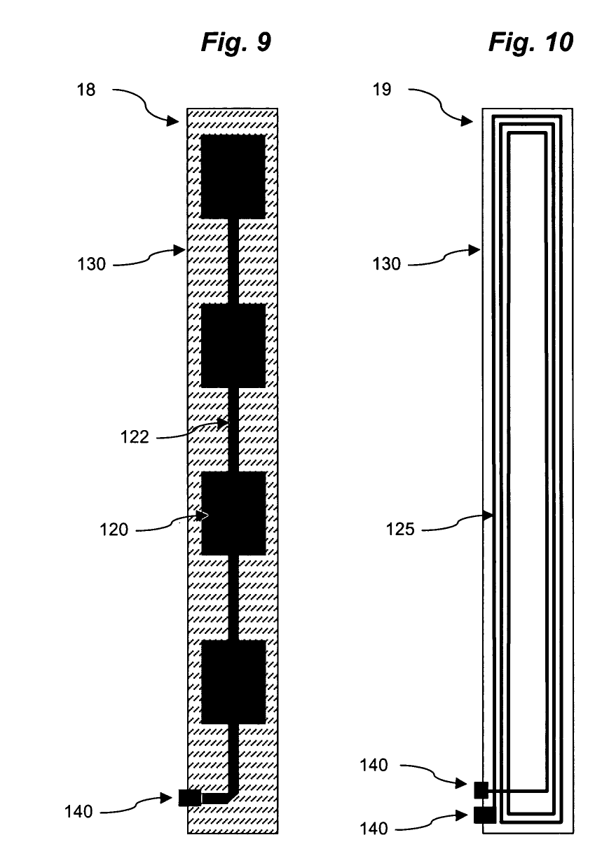

FIG. 9 is a schematic illustration of a series-fed multiple patch element high frequency portal antenna 18, in which electromagnetic energy is radiated from patch antenna elements 120 that are resonant at the frequency of operation. The patch radiating elements are mounted on a printed circuit board dielectric substrate 130, and are interconnected using microstrip transmission feed elements 122. The interface to the RF feed cable 140 accommodates an edge-style RF connector.

FIG. 10 is a schematic illustration of a low frequency portal antenna 19, in which electromagnetic energy is inductively coupled from the coil antenna element 125 of the portal antenna to RFID tag antennas. The coils antenna element 125 is mounted on a printed circuit board substrate 130. The interface to the RF feed cable 140 accommodates an edge-style connector.

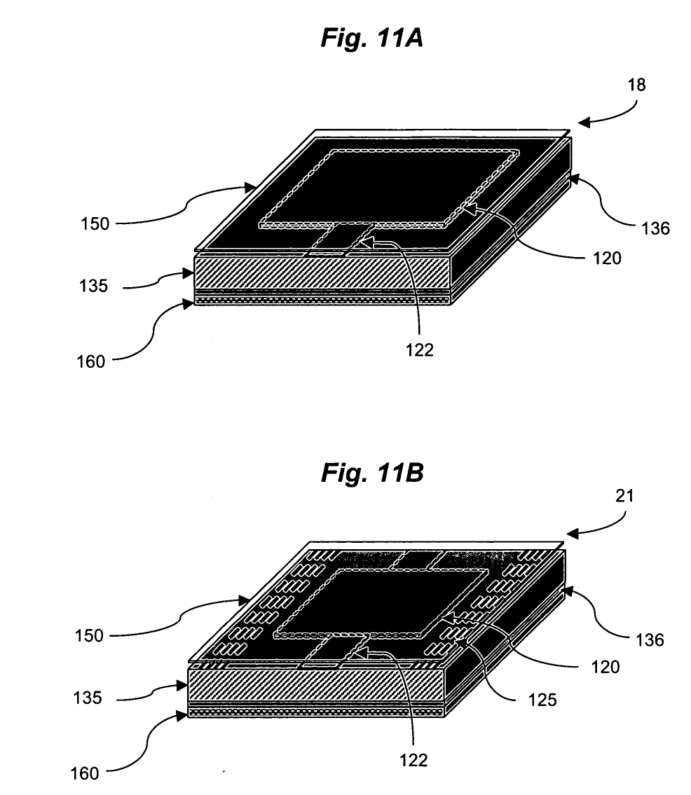

FIG. 11A is a schematic illustration showing the construction of a high frequency portal antenna 18, in which the radiating element or multiple elements 120 and microstrip transmission line elements 122 are mounted on a low-loss dielectric substrate material 135, backed by a conductive ground plane 136, and covered with a protective layer 150 that may also serve as a waterproof radome. This view also shows an adhesive layer 160 below the conductive ground plane 136 that may be used to mount the portal antenna 18.

FIG. 11B is a schematic illustration showing the construction of a multiple-mode high frequency and low frequency portal antenna 21, which incorporates both resonant high frequency radiating elements 120 and a low frequency inductive coil 125. In this view a high frequency radiating element 120 is shown in the center of the composite antenna structure, and the conductive traces that form the inductive coil 125 are shown toward the edge of the composite antenna structure. The radiating elements 120 and the transmission line elements 122 are mounted on a low-loss dielectric substrate material 135, backed by a conductive ground plane 136, and covered with a protective layer 150 that may also serve as a waterproof radome. This view also shows an adhesive layer 160 below the conductive ground plane 136 that may be used to mount the portal antenna 21. The portal antenna 21 may be used with RFID tags that operate at a variety of operating frequencies.

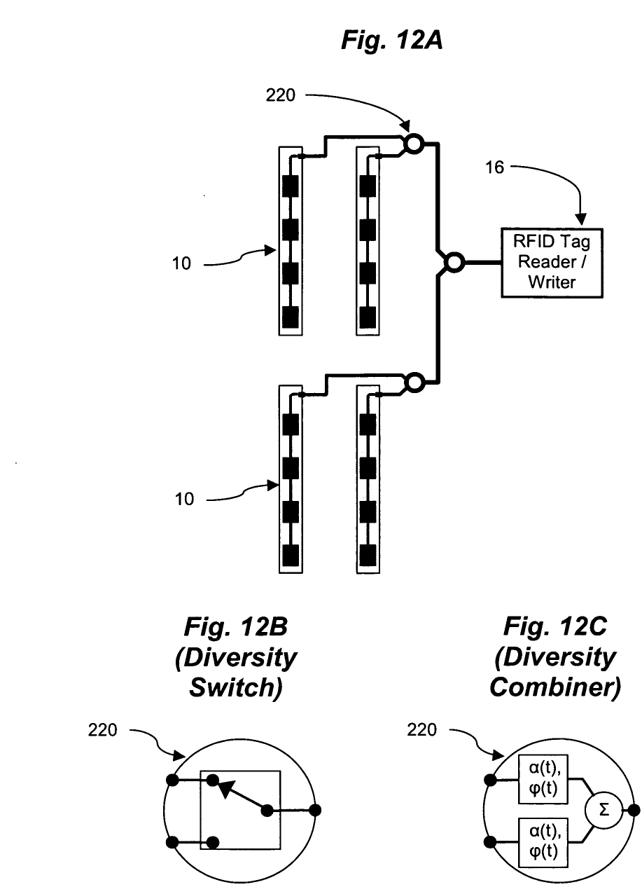

FIG. 12A is a schematic illustration showing the use of diversity switching or diversity combining of the signals from multiple portal antenna elements 10, with the objective of improving antenna performance and increasing the accuracy of RFID tag reading and/or writing. In this view the diversity control elements 220 are represented as the circles in which multiple signals are switched or combined to produce a single signal for interface with the RFID tag reader/writer 16.

FIG. 12B is a schematic illustration showing a diversity control element 220 in which multiple input signals are switched to produce a single output signal.

FIG. 12C is a schematic illustration showing a diversity control element 220 in which multiple input signals are combined using amplitude and/or phase weights, followed by a summation of the multiple weighted signals, to produce a single output signal.

An additional embodiment of the invention incorporates the application of Photonic Band Gap (PBG) antenna technology for use in low-profile portal antennas. The incorporation of PBG electromagnetic substrates provides a low loss, high dielectric constant substrate for antenna radiating elements, thereby shrinking the lateral dimensions of the portal antenna. Additionally, the PBG structure within the substrate produces a high-impedance electromagnetic surface that approximates a perfect magnetic conductor (PMC), thereby shrinking the antenna profile (i.e. height). The PBG structure may be fabricated as periodic voids within the substrate, or as an embedded metallic-dielectric structure. The spacing of the voids or metallic elements is controlled so as to produce a high impedance at the frequency of operation. The high-impedance reflective surface that eliminates the 180-degree phase inversion associated with RF reflections from conventional low-impedance metallic ground planes. Using a PBG substrate, the antenna radiating elements may be placed in close proximity to the reflective high-impedance surface, leading to an antenna structure that is low in profile. This is not possible using conventional metallic substrates, since the phase inversion associated with reflections from a low-impedance surface causes the reflected to cancel the energy that is radiated directly from antenna radiating element.

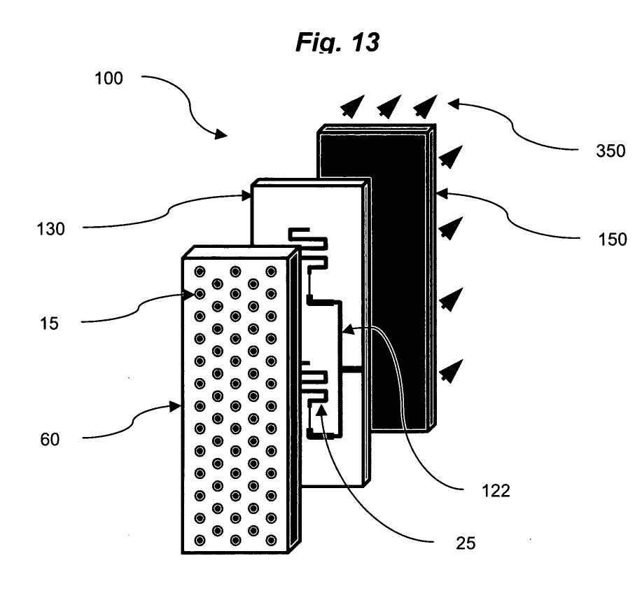

FIG. 13 is a schematic illustration showing the construction of a portal antenna 100 based on the use of a Photonic Band Gap (PBG) antenna substrate 60, in which the radiating elements are meander-line antennas 25 that are mounted immediately adjacent to the high-impedance PGB substrate 60, thereby forming the electrically small, low-profile portal antenna 100. The PBG substrate 60 is fabricated as a composite metallic-dielectric material, with the spacing between the metallic elements 15 in the substrate controlled so as to create a high-impedance surface at the antenna operating frequency. The radiating elements 25 and microstrip transmission line elements 122 are mounted on a low-loss printed circuit board dielectric substrate material 130. The radiating elements 25 are covered with a protective layer 150 that may also serve as a waterproof radome. The use of the PBG substrate causes radiated energy 350 to be reflected away from the substrate, in phase with the energy radiated directly from the antenna radiating elements 25.

Although the invention has been described with respect to various embodiments, it should be realized that this invention is also capable of a wide variety of further and other embodiments within the spirit and the scope of the appended claims.

What is claimed is:

1. An antenna for communicating with an RFID transponder, the antenna comprising
an antenna integrated into a portal, said portal substantially enclosing an opening.

2. The antenna of claim 1, wherein integration of the antenna into the portal is concurrent with manufacture of the portal.

3. The antenna of claim 1, wherein the integrated antenna is a patch antenna.

4. The antenna of claim 3, wherein the integrated antenna is a multi-element patch antenna including a plurality of patch antennas.

5. The antenna of claim 4, further including microstrip transmission line elements connecting said patch antennas.

6. The antenna of claim 3, wherein the plane of said patch antenna is parallel to a plane defining said opening of said portal.

7. The antenna of claim 1, wherein the antenna is a Photonic Band Gap antenna.

8. The antenna of claim 7, wherein the integrated antenna is a multi-element Photonic Band Gap antenna including a plurality of radiating elements.

9. The antenna of claim 7, wherein the Photonic Band Gap antenna further includes at least one printed circuit radiating element.

10. The antenna of claim 9, wherein said printed circuit radiating element is in close proximity to a high-impedance reflective back plane.

11. The antenna of claim 10, wherein said printed circuit radiating element is less than or equal to one-tenth of a wavelength from said high impedance reflective backplane.

12. The antenna of claim 1, wherein the integrated antenna is a loop antenna.

13. The antenna of claim 12, wherein the plane bounded by said loop antenna is parallel to the plane bounded by said portal.

14. The antenna of claim 13, wherein said plane bounded by said loop antenna lies beyond said opening of said portal.

15. The antenna of claim 1, wherein said portal further comprises a door frame.

16. The antenna of claim 1, wherein said portal further comprises a plurality of unconnected boundaries.

17. The antenna of claim 1, wherein said antenna is integrated into a vehicle.

18. A system for communicating with an RFID transponder, the system comprising:
a first antenna, the first antenna capable of transmitting and receiving high frequency electrical signals;
a second antenna, the second antenna capable of transmitting and receiving low frequency electrical signals; and
a switch, the switch selectively enabling transmission and reception at the high frequency, at the low frequency, or at both the high and the low frequencies.

19. The system for communicating of claim 18, wherein the first antenna is a patch antenna.

20. The system for communicating of claim 19, wherein the second antenna is a loop antenna.

21. The system for communicating of claim 18, wherein the first antenna is a Photonic Band Gap antenna.

22. The system for communicating of claim 21, wherein the second antenna is a loop antenna.

23. A method for communicating with an RFID transponder, the method comprising:
transmitting electrical signals to the RFID transponder and receiving electrical signals from the RFID transponder via a plurality of antennas integrated into a portal.

24. The method for communicating of claim 23, further comprising transmitting the electrical signals received from the RFID transponder to a wide area wireless data network.

25. The method for communicating of claim 24, wherein the wide area wireless data network is based on the IEEE 802.11 standard.

26. The method for communicating of claim 23, further comprising switching between the plurality of integrated antennas.

27. The method for communicating of claim 23, further comprising combining the electrical signals received from the plurality of integrated antennas.

28. The method for communicating of claim 27, wherein said combining comprises summing the electrical signals and individual phasing of the electrical signals.

29. The method for communicating of claim 27, wherein said combining comprises weighting of the electrical signals.

30. A method of integrating an antenna with a portal, the method comprising:
integrating the antenna into the portal during manufacture of the portal.

31. An antenna for communicating with an RFID transponder, the antenna comprising:
an antenna mounted outside a portal, said portal substantially enclosing an opening.

32. The antenna of claim 31, wherein the antenna is adhesively mounted to a surface beyond said portal.
